(19) United States
(12) Patent Application Publication
(10) Pub. No.: US 2007/0144218 A1
(43) Pub. Date: Jun. 28, 2007

(54) Longlife bushing tip

(76) Inventors: Anthony P. Oakleaf, New Albany, OH (US); Byron L. Bemis, Newark, OH (US)

Correspondence Address: OWENS CORNING, 2790 COLUMBUS ROAD, GRANVILLE, OH, 43023, US

(21) Appl. No.: 11/319,708

(22) Filed: Dec. 28, 2005

(51) Int. Cl. C03B 37/085; C03B 5/00

(52) U.S. Cl. 65/495; 29/DIG. 48

(57) ABSTRACT

A fiber forming bushing comprises a baseplate having at least one hole and a bushing tip that is formed separately from the baseplate, supported in the hole in the baseplate, and welded to the baseplate. The bushing tip has an upper end and a lower end, and comprises a flange at the upper end of the bushing tip. A tapered entrance is provided at the upper end adjacent the flange. An upper cylindrical portion is provided adjacent the tapered entrance. A tapered middle portion is provided adjacent the upper cylindrical portion. A lower cylindrical portion is provided adjacent the tapered middle and extended to at outlet at the lower end of the bushing tip.

### TECHNICAL FIELD AND INDUSTRIAL APPLICABILITY OF THE INVENTION

This invention relates in general to fiber forming bushings suitable for making mineral fibers, and more particularly to a tip for a fiber forming bushing. The present invention also relates to a method of manufacturing a fiber forming bushing.

### BACKGROUND OF THE INVENTION

A bushing is one of the most critical components in the manufacture of quality continuous-strand glass fibers. The bushing is generally made of an alloy of platinum and rhodium (Pt—Rh) and is in the form of a box into which molten glass is delivered. The box has a baseplate that is perforated by numerous holes. Each of these holes is constituted by a pierced jet known as a “tip” through which the glass flows out to produce a fiber once it has been attenuated.

In a “direct-melt” bushing technique, the glass is fed in the molten state but, in order to maintain thermal equilibrium, it is necessary to heat the body of the bushing by the Joule effect. The plate constituting the baseplate has several hundred or even several thousand tips, and in bushings already in existence or under development, the number of tips can be as great as 4,000 or even 6,000 or more.

In general, in order to avoid deformation of the baseplate, it is known to distribute mechanical reinforcement over the length thereof and between the locations of the tips, thereby ensuring better stiffness in use.

Present technologies for manufacturing bushings, and in particular for manufacturing bushing baseplates, need to take account of economic constraints associated with fiber production or with drawing from a bushing, and of techniques associated with the geometry and the number of tips per unit area of baseplate through which fibers can be drawn.

In accordance with current methods, bushing baseplates are manufactured by forming or drilling the tip geometry into the baseplate material. Manufacturing baseplates in this manner uses a lot of precious metal. The tips formed or drilled therein are typically conical in shape and have a relatively large inlet, which decreases the packing density and increases the total weight of the baseplate. Exposing the tips to air at high temperatures also causes the tips to erode. As erosion occurs at the tip outlets, the fibers formed therethrough increase in diameter. Since the tip outlets erode at different rates, the fiber diameters grow at various rates, which produces an unacceptable product.

### SUMMARY OF THE INVENTION

The present invention is directed toward a fiber forming bushing comprising a baseplate and a bushing tip. The baseplate has at least one hole therein. The bushing tip is formed separately from the baseplate, supported in the hole in the baseplate, and welded to the baseplate. The bushing tip has an upper end and a lower end, and comprises a flange at the upper end of the bushing tip. A tapered entrance is provided at the upper end adjacent the flange. An upper cylindrical portion is provided adjacent the tapered entrance. A tapered middle portion is provided adjacent the upper cylindrical portion. A lower cylindrical portion is provided adjacent the tapered middle and extended to at outlet at the lower end of the bushing tip.

### BRIEF DESCRIPTION OF THE DRAWINGS

FIG. 1 is a side perspective view of a long-life tip for a fiber forming bushing.

FIG. 2 is a top plan view of the long-life tip shown in FIG. 1.

FIG. 3 is a sectional view in elevation of the long-life tip taken along the line 3-3 in FIG. 2.

FIG. 4 is a partial sectional view in elevation of a baseplate with a long-life tip shown in FIG. 3.

### DETAILED DESCRIPTION OF THE PREFERRED EMBODIMENTS OF THE INVENTION

The description and drawings disclose a fiber forming bushing suitable for making glass fibers. It is to be understood that the bushing can be configured to form fibers of other mineral material.

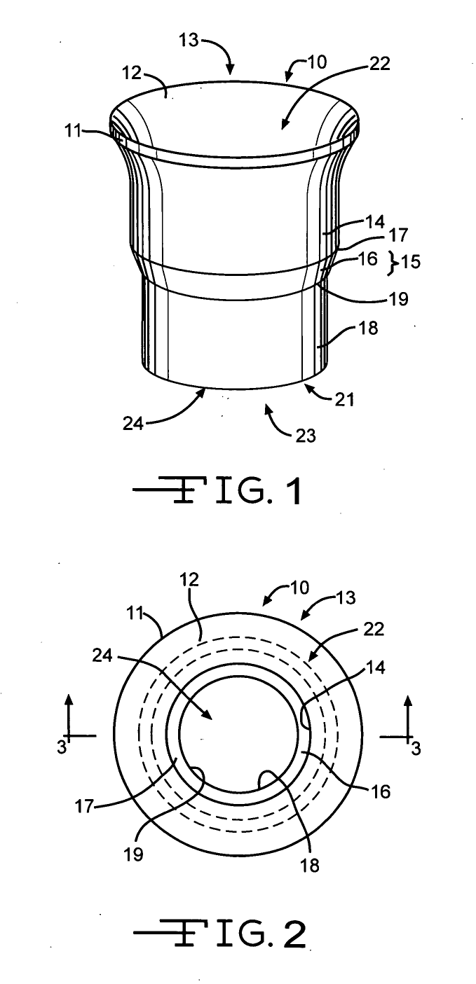

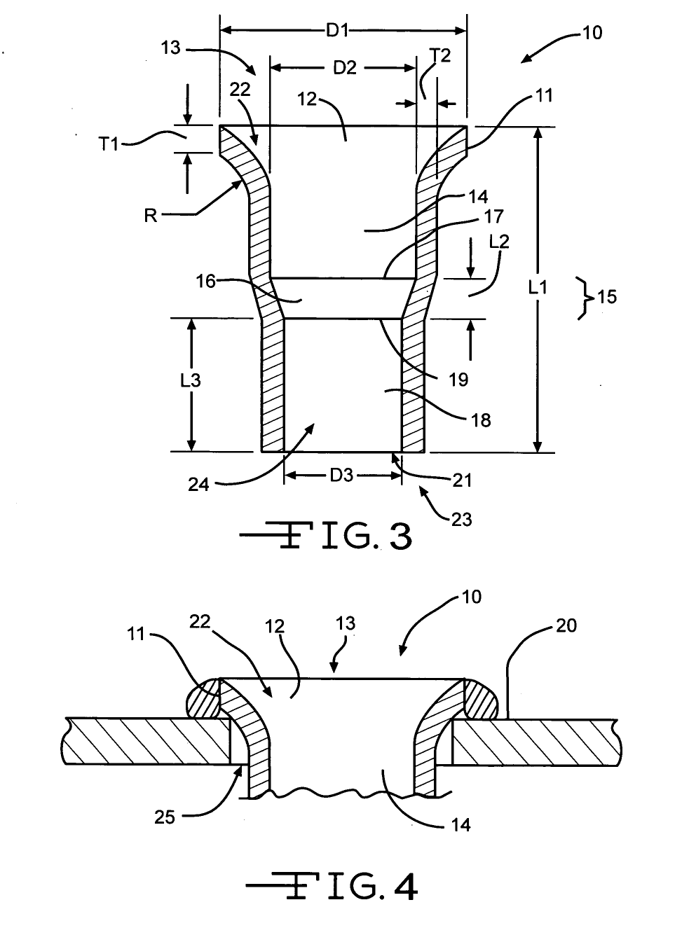

Referring now to the drawings, there is illustrated in FIGS. 1-3 a bushing tip 10 used to form continuous glass fibers. The bushing tip 10 may be formed of platinum and rhodium (Pt—Rh). The bushing tip 10 has a thin wall 9 that has a substantially uniform thickness. The bushing tip 10 has a flange 11 at its upper end 13 adjacent a tapered entrance 12. More particularly, the entrance 12 is flared so that its shape spreads outward in the form of an inverted bell-shaped profile when viewed in cross-section. The tapered entrance 12 makes a smooth transition to an upper cylindrical portion 14 and provides material for the weld attachment. An intermediate portion 15 of the bushing tip 10 is necked down to form a tapered middle portion 16. There is a clear line of demarcation (i.e., a definite angle change in the bushing tip wall) at the upper and lower ends 17, 19 of the tapered middle portion 16. The lower end 19 of the tapered middle portion 16 leads to a lower cylindrical portion 18 at an outlet end 21 of the bushing tip 10.

The bushing tip 10 has a wall thickness in a range from about 0.007 inch to about 0.015 inch, and has a substantially uniform thickness, although other thicknesses can be used. The thickness of the flange 11 may be slightly greater than the thickness of the remaining portions of the bushing tip 10. For example, the thickness T1 of the flange 11 may be about 0.015 inch and the thickness T2 of the remaining portions of the bushing tip 10 may be about 0.011 inch. With regard to transverse dimensions, the upper end 13 of the bushing tip 10 has an internal diameter D1 that is preferably in a range from about 0.080 inch to about 0.134 inch, although other dimensions can be used. The outer radius R of the inverted bell-shaped profile is as required dependent on the diameter D1 of the upper end 13 of the bushing tip 10 and the internal diameter D2 of the upper cylindrical portion 14. The lower cylindrical portion 18 preferably has an internal diameter D3 in a range from about 0.058 inch to about 0.1 inch, but also can have other values. With regard to axial dimensions, the overall length L1 of the bushing tip 10 is preferably about 0.165 inch, with the length L2 of the tapered middle portion 16 being less than about 0.025 inch and the length L3 of the lower cylindrical portion 18 being about 0.065 inch. It is to be understood that all of the ranges of dimensions disclosed above are exemplary, and can have other values.

The tapered middle portion 16 according to the invention reduces the alloy weight of the bushing tip 10 over conventional bushing tips because it maintains a relatively thin wall thickness, while still enabling maximization of throughput by minimizing pressure drop through the bushing tip 10. The fact that the lower portion 18 is cylindrical allows for easier plugging when necessary, and enables better control of the fiber diameter as the bushing tip lift 10 erodes. As a result, the bushing tip 10 of the present invention has an extended life, which also has a bearing on the alloy needed to support fiber forming operations.

The diameters D1, D2, D3 of the inlet 22 at the tapered entrance 12 of the bushing tip 10 and the outlet end 19 of the bushing tip 10 at the lower end 23 of the bushing tip 10 in the current invention, when combined with the overall length L1 of the bushing tip 10, provide a bushing tip 10 that yields the same throughput as a conventional bushing tip but with a reduced bushing tip net weight, and a smaller diameter D1, D2, D3 at the inlet and outlet 22, 24. The smaller diameter D1, D2 of the inlet 22, for a given throughput, also enables an increase in the packing density, which reduces the total weight of the precious metal forming the baseplate 20 and the amount of precious metal required to construct the bushing. The smaller diameter D3 at the outlet 24 also provides reduced fiber tension at higher throughputs. The ratios between the diameters D1, D2, D3 of the inlet and outlet 22, 24 and the length L1 are chosen specifically to optimize the precious metal usage for the entire bushing, while maximizing the specific throughput and minimizing the fiber forming tension. The optimized shape of the design allows for tight packing, while the tapered middle portion 16 and the shorter overall length L1 permits small exits at the same throughput, which in turn prevents tip-to-tip flooding at the high packing densities.

As shown in FIG. 4, the bushing tip 10 is supported by a baseplate 20. It should be noted that the bushing tip 10 according to the invention is a separately formed, finished part that is inserted through a hole 25 in the baseplate 20. Preferably, the bushing tip 10 is precisely fit into a previously-punched, precisely-located hole 25 in the baseplate 20 and welded around its flange 11 by any welding methodology to ensure a structurally sound and leak-tight joint.

When the bushing tip 10 is exposed to air at high temperatures, the Pt—Rh erodes due to oxidation of the Pt—Rh. In bushings with conventional tips, this erosion leads to the undesirable result of larger fiber diameters. The cylindrical shape of the and constant wall thickness of the lower portion 18 of the bushing tip 10 gives more control over fiber diameter as the bushing tip 10 erodes. This in turn provides a more stable diameter for the fiberglass product and a longer bushing life. In addition, the cylindrical outlet end 21, unlike a conical shaped outlet end, creates an easily pluggable bushing tip 10.

A method of manufacturing a fiber forming bushing comprises the step of providing a baseplate 20 having at least one hole 25 therein. A bushing tip 10 is also provided. The bushing tip 10 is formed separately from the baseplate 20. The bushing tip 10 comprises a flange 11 at an upper end 13 of the bushing tip 10, a tapered entrance 12 at the upper end 13 adjacent the flange 11, an upper cylindrical portion 14 adjacent the tapered entrance 12, a tapered middle portion 16 adjacent the upper cylindrical portion 14, and a lower cylindrical portion 18 adjacent the a tapered middle portion 16 and extending to an outlet 24 at the lower end 23 of the bushing tip 10. The bushing tip 10 is supported in the hole 25 in the baseplate 20. Lastly, the bushing tip 10 is welded to the baseplate 20.

Although only one hole 25 and bushing tip 10 is shown in drawings, it is to be understood that typically the bushing baseplate 20 may be provided with many holes 25 and bushing tips 10.

The combination of the portions of the bushing tip 10 gives optimal performance in all of criteria, including alloy weight, throughput, flooding resistance, packing density, cost to manufacture, weldability, and more. The length L3 of the lower cylindrical portion 18 is preferably long enough to prevent bushing tip erosion from reaching the tapered middle portion 16 of the bushing tip 10 and may be optimized for each application if desired.

In accordance with the provisions of the patent statutes, the principle and mode of operation of this invention have been explained and illustrated in its preferred embodiment. However, it must be understood that this invention may be practiced otherwise than as specifically explained and illustrated without departing from its spirit or scope.

What is claimed is:

1. A fiber forming bushing, comprising:
a baseplate having at least one hole therein; and
a bushing tip formed separately from the baseplate and supported in the hole in the baseplate, the bushing tip being welded to the baseplate, the bushing tip having an upper end and a lower end, and comprising:
a flange at the upper end of the bushing tip;
a tapered entrance at the upper end adjacent the flange;
an upper cylindrical portion adjacent the tapered entrance;
a tapered middle portion adjacent the upper cylindrical portion; and
a lower cylindrical portion adjacent the tapered middle portion and extended to an outlet at the lower end of the bushing tip.

2. The fiber forming bushing according to claim 1, wherein the tapered entrance makes a smooth transition to the upper cylindrical portion.

3. The fiber forming bushing according to claim 1, wherein the tapered entrance is flared so as to have a shape that spreads outward in the form of an inverted bell-shaped profile.

4. The fiber forming bushing according to claim 1, wherein a clear line of demarcation is at upper and lower ends of the tapered middle portion between the tapered middle portion and the upper and lower cylindrical portions.

5. The fiber forming bushing according to claim 1, wherein the bushing tip is formed of platinum and rhodium (Pt—Rh) or other appropriate material.

6. The fiber forming bushing according to claim 1, wherein the bushing tip has a wall that has a substantially uniform thickness extending from the upper end to the lower end of the bushing tip.

7. The fiber forming bushing according to claim 1, wherein the bushing tip has a wall that has a thickness in a range from about 0.007 to about 0.015 inch.

8. The fiber forming bushing according to claim 1, wherein the internal diameter of the lower cylindrical portion is less than the internal diameter of the upper cylindrical portion.

9. The fiber forming bushing according to claim 8, wherein the upper end of the bushing tip has an internal diameter that is a range from about 0.080 to about 0.134 inch, and the lower cylindrical portion has an internal diameter in a range from about 0.05 to about 0.1 inch or as appropriate for the forming conditions.

10. The fiber forming bushing according to claim 1, wherein the bushing tip has an overall length of about 0.165 inch, the tapered middle portion has a length less than about 0.025 inch, and the lower cylindrical portion has a length of about 0.065 inch.

11. The fiber forming bushing according to claim 1, wherein the bushing tip is welded to the baseplate.

12. A fiber forming bushing, comprising:
a baseplate having at least one hole therein; and
a bushing tip formed separately from the baseplate and supported in the hole in the baseplate, the bushing tip being welded to the baseplate, the bushing tip having an upper end and a lower end, and having a wall that has a substantially uniform thickness extending from the upper end to the lower end of the bushing tip and comprising:
a flange at the upper end of the bushing tip;
a tapered entrance at the upper end adjacent the flange, the tapered entrance being flared so as to have a shape that spreads outward in the form of an inverted bell-shaped profile;
an upper cylindrical portion adjacent the tapered entrance, the tapered entrance making a smooth transition to the upper cylindrical portion;
a tapered middle portion adjacent the upper cylindrical portion; and
a lower cylindrical portion adjacent the a tapered middle and extended to an outlet at the lower end of the bushing tip.

13. The fiber forming bushing according to claim 12, wherein the tapered entrance makes a smooth transition to the upper cylindrical portion.

14. The fiber forming bushing according to claim 12, wherein a clear line of demarcation is at upper and lower ends of the tapered middle portion between the tapered middle portion and the upper and lower cylindrical portions.

15. The fiber forming bushing according to claim 12, wherein the bushing tip is formed of platinum and rhodium (Pt—Rh) or other appropriate material.

16. The fiber forming bushing according to claim 12, wherein the bushing tip has a wall that has a thickness in a range from about 0.011 to about 0.015 inch.

17. The fiber forming bushing according to claim 8, wherein the upper end of the bushing tip has an internal diameter that is a range from about 0.080 to about 0.134 inch, and the lower cylindrical portion has an internal diameter in a range from about 0.05 to about 0.1 inch or as appropriate for the forming conditions.

18. The fiber forming bushing according to claim 12, wherein the bushing tip has an overall length of about 0.165 inch, the tapered middle portion has a length less than about 0.025 inch, and the lower cylindrical portion has a length of about 0.065 inch.

19. The fiber forming bushing according to claim 12, wherein the bushing tip is laser welded to the baseplate.

20. A method of manufacturing a fiber forming bushing comprising the steps of:
a) providing a baseplate having at least one hole therein;
b) providing a bushing tip that is formed separately from the baseplate, and wherein the bushing tip comprises a flange at an upper end of the bushing tip, a tapered entrance at the upper end adjacent the flange, an upper cylindrical portion adjacent the tapered entrance, a tapered middle portion adjacent the upper cylindrical portion, and a lower cylindrical portion adjacent the a tapered middle and extended to an outlet at the lower end of the bushing tip;
d) supporting the bushing tip in the hole in the baseplate; and
e) welding the bushing tip to the baseplate.
